(19) United States
(12) Patent Application Publication
(10) Pub. No.: US 2003/0192193 A1
(43) Pub. Date: Oct. 16, 2003

(54) Measuring fishtape

(76) Inventors: Ryan Duane Potts, Castaic, CA (US); Stefani Lynn Potts, Castaic, CA (US)

Correspondence Address: Ryan Duane Potts, 30415 Sloan Cyn Rd., Castaic, CA, 91384, US

(21) Appl. No.: 10/053,322

(22) Filed: Apr. 11, 2002

(51) Int. Cl. G01B 3/10

(52) U.S. Cl. 33/759

(57) ABSTRACT

Electrical companies have more than just one fishtape, and some of those fishtapes are broken. Either the plastic handle is broken off or the metal tape is cut short and not the original length. The only other device of this kind that has a measuring device, it is on the handle. This has no purpose when the handle is broken off. As an electrician, it would be much easier to have the measurements marked on the tape, so you would know how long the metal tape is before you even begin. This again, eliminates wasted time.

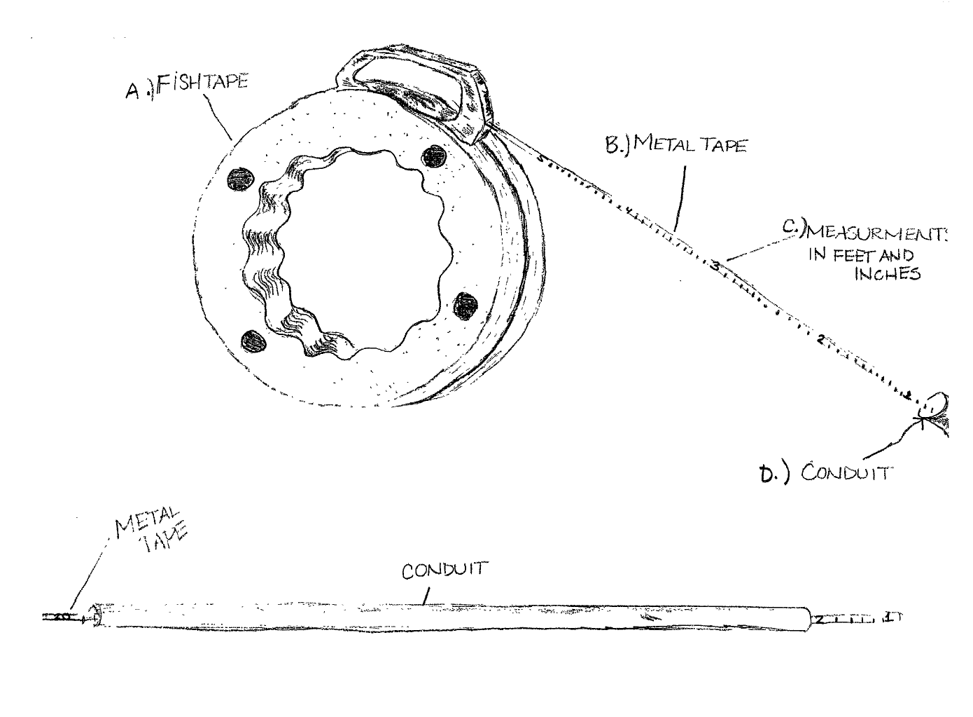

Electrical companies usually carry a variety of different brands of fishtapes. This is because most people buy whatever is cheaper and will save them money. However, if a product were available to these employers that would save there employee's time “on the clock,” this product would save employers thousands of dollars.

There are two things in this world that everyone needs more of, that is, TIME and MONEY. The measuring fishtape saves electricians on the job time, therefore saving there employers money. Any employer would see this as a huge advantage in purchasing this product. A product of this nature could monopolize the market of fishtapes as a whole.

The measuring fishtape is s metal tape that is approximately ⅛ inch wide and ranging from 50 feet long to 200 feet long. (FIG. B).

The metal tape is rolled up in a plastic casing, which is used to unroll and roll up the metal tape. (FIG. A.)

The metal tape has measuring marks in the increments of inches and feet marking to the end of the metal tape. (FIG. C.)

The measuring fishtape is made by, either stamping, or etching the measurements on the metal tape.

The measuring fishtape is used for measuring the conduit or flex to get an exact measurement of the conduit, so that the electrician can cut the exact amount of wire that he needs. This will help the electricians use their time more efficiently. They will not have to mark the fish tape, pull the fishtape out of the conduit, measure the wire, and then push the fishtape back through to pull the wire. This product essentially eliminates 3 out of 5 of these time consuming procedures in pulling wire.

1. What we claim as our invention is a metal tape marked with measurements in the increments of feet and inches, which is rolled up in a plastic casing in which allows the tape to be unrolled and rolled up again.
